(19) United States
(12) Patent Application Publication
(10) Pub. No.: US 2026/0224989 A1
(43) Pub. Date: Aug. 6, 2026

(54) VIDEO GAME PLAY NARRATION

(71) Applicants: Sony Interactive Entertainment Inc., Tokyo (JP); Sony Interactive Entertainment LLC, San Mateo, CA (US)

(72) Inventors: Todd Tokubo, Newark, CA (US); John Blake, Belmont, CA (US)

(73) Assignees: Sony Interactive Entertainment Inc., Tokyo (JP); Sony Interactive Entertainment LLC, San Mateo, CA (US)

(21) Appl. No.: 19/045,123

(22) Filed: Feb. 4, 2025

(51) Int. Cl. A63F 13/54; A63F 13/60

(52) U.S. Cl. CPC A63F 13/54; A63F 13/60

(57) ABSTRACT

Methods, systems, and code that can provide enhancements to content recorded during a game session of a game program. An example can provide a narration or other enhancement to the content. The narration can be added to a video segment of a game session of a game program.

### BACKGROUND

Video games can be an incredibly immersive form of entertainment. Whether played alone or in groups over the internet, video games can be challenging and engaging. On occasion, something can happen during a game that is somewhat remarkable. When this happens, it can be desirable to be able to share a recording of the event. It can further be desirable to enhance the recording to be shared in order to make it even more interesting. Thus what is needed are methods, systems, and code that can provide enhancements to content recorded during a game session of a game program.

### BRIEF DESCRIPTION OF THE DRAWINGS

FIG. 1 is a flowchart illustrating the generation of a narration for a video game segment according to an embodiment of the present invention;

FIG. 2 illustrates an example of a player interacting with an illustrative gaming system capable of generating narration for a recorded video game segment according to an embodiment of the present invention;

FIG. 3A illustrates various modules, models, and content that can be used when producing a narration for a video game segment, while FIG. 3B illustrates a graphical user interface for selecting a style of narration according to an embodiment of the present invention;

FIG. 4 is a flowchart illustrating the operation of a gaming console according to an embodiment of the present invention;

FIG. 5 is a flowchart illustrating the operation of a gaming console according to an embodiment of the present invention;

FIG. 6 is a flowchart illustrating the operation of a server according to an embodiment of the present invention;

FIG. 7 is a flowchart illustrating the sharing of tasks between a gaming console and a server according to an embodiment of the present invention;

FIG. 8 is another flowchart illustrating the sharing of tasks between a gaming console and a server according to an embodiment of the present invention;

FIG. 9 is another flowchart illustrating the sharing of tasks between a gaming console and a server according to an embodiment of the present invention; and

FIG. 10 illustrates an example of a hardware system suitable for implementing a computer system, according to an embodiment of the present disclosure.

In the appended figures, similar components and/or features can have the same reference label.

### DESCRIPTION OF ILLUSTRATIVE EMBODIMENTS

Embodiments of the present invention can provide methods, systems, and code that can provide enhancements to content recorded during a game session of a game program. An illustrative embodiment of the present invention can provide a narration or other enhancement to the content, which can be a video segment. The narration can be added to a video segment of a game session of a game program.

The narration can focus on events during the game session that are to some degree rare. The rarer an event, the more the narration can be focused on the event. For example, particularly rare events can elicit an appropriately enthusiastic response in the narration. The narration can be descriptive, the narration can be fanciful, the narration can be a combination of these or it can have another narration style. The narration can be more freeform as compared to descriptive. In other embodiments, the narration can focus on identifying other attributes of an event. For example, how funny or startling an event is may be the focus of the narration.

In these and other embodiments of the present invention, a gaming system can include a gaming console and a server. The gaming system can detect or identify an event in a video segment of a game session of a game program. The gaming system can determine a rarity of the event, and then can generate a narrative based on the rarity of the event. The narration can then be added to the video segment. The combined video segment and its narration can be added to a player's library of video segments for sharing on social media and the like.

An event can be detected in various ways. For example, a gaming console running a game program can detect car crashes, passes, spinouts, and other events in a racing game. In another example, a gaming console running a game program can detect how quickly or effortlessly a “boss” is defeated in a boss fight or how little damage a character sustained during a particularly difficult fight. This can be done natively by the game program, for example when allocating or deducting points, extra time, or other incentive or disincentive in the game session for various achievements and failures. Since these events are already being tracked by the game program, they can be provided along with the corresponding video segment to a server. For example, the events can be tagged and bookmarked in the video segment and provided to the server. The gaming console can also identify events by following a chat channel of a game session. An event can be identified when an action in a game session elicits an excited or other response from one or more players of the game.

In these and other embodiments of the present invention, a server can detect events. For example, a gaming console can provide a video segment with a recording from a chat channel to the server. The server can review the recording and detect events. An event can be identified when an action in a game session elicits an excited or other response from one or more players of the game. A server can further store a set of patterns that can be compared to patterns in the video segment. An event can be identified when an event that is similar to a pattern in the set of patterns occurs. The server can determine the presence of an event in the video segment using a machine learning model that has been trained to identify the presence of events in video segments of game sessions of the game program. In these and other embodiments of the present invention, the gaming console and the server can both detect events.

The rarity of an event can be determined in various ways. For example, a gaming console running a game program can award or deduct points, extra time, or other incentive or disincentive for the various events that occur in a game session as a native part of the game program. The game program can have a rarity score for different events that can occur during a game session. This rarity score can be used in determining the magnitude of incentives and disincentives, or it can be separate. This information, such as incentives and disincentives, rarity scores, and other information, can be added to the corresponding video segment and provided to a server. The gaming console can further use other information to determine the rarity of an event. For example, when detecting the presence of an event using a chat channel, the gaming console can additionally determine a rarity score or indication based on the level of excitement or other response from elicited by one or more players of the game. In another example, the rarity score may be determined by certain attributes of in-game objects, such as rarity of the weapons or other “perks” used during the game, level of the in-game characters (characters at a higher level being more likely to execute difficult actions), and game level (high levels are more difficult and thus more likely to have rare events). In another example, the rarity score may also depend upon in-game upgrades, such as in-game power-ups and enhancements.

In these and other embodiments of the present invention, a server can determine the rarity of an event. For example, the server can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session. The sever can also monitor a chat channel for specific types of responses from the players of the game session. A rarity score or other indication can be assigned based on the level of excitement or other response from elicited by one or more players of the game.

A narration can be generated for a video segment using the events and their corresponding rarity score or other indication. The narration can be generated based at least in part on the rarity of events in the video segment. The narration can be generated by a server using a machine learning model that has been trained to generate narrations of video segments of game sessions of the game program based at least in part on the rarity of an event. The narration can have an increased level of enthusiasm and detail for events that is proportional to the rarity of the event be described. That is, statistically rare events can be highlighted in the narration. The tone, excitement level, and other aspects of the narration can track the events in the video segment being narrated. Rarer and more exciting events can elicit appropriately enthusiastic responses from the narration.

The narration can have a style. Various types of styles can be used, such as sarcasm, sports play-by-play, styles based on popular culture, and others. The style can be selected by a user, for example using a menu that is provided by the gaming console using a graphical user interface. The style can be chosen by either the gaming console or a server based on the identity of the game program. The style can be chosen based on the rarity of one or more events in the game session being narrated. The style can be chosen based on an age of a player of the game session, the time or season of the year, or other factors.

The narration can be provided using one or more formats. For example, the narration can be one or more voices or other audio, video, external content, text, graphical additions such as avatars or other graphical characters, or a combination of these. For example, graphical characters can point out playing errors in the video segment. Graphical characters can have a level of enthusiasm and interaction that reflects the rarity of events being described in the narration.

The narration can include descriptions from one, two, three, or more than three virtual narrators. These virtual narrators can be in conversation with each other. The one or more virtual narrators can discuss the content of the video segment as well as other non-game related topics. For example, they can discuss news relating to topics that a game player is interested in. The narrative voices can be from an outside point of view, from an NPC (non-player character), another player, an enemy in the game program, or other point of view.

Audio portions of the narration can be overlayed or they can replace music or other audio from the game session. Portions of a recording of a chat channel of the game session can be included as part of the narration. Music or other audio that is not from the game session can be added to highlight one or more events of the video segment. A new musical track can be generated and added to the video segment, where the musical track is tied to the events of the video segment or has a rhythm based on the events of the video segment. Video clips from other sources or other video segments can be added as part of the narration. The added audio and video clips can be pulled from popular culture, or they can be generated by a server using a machine learning model that has been trained to generate such audio and video clips.

Once the narration is generated, it can be aligned with and added to the video segment of the video session of the game program. The alignment can be done to ensure that narration description is timed to the event of the video segment. Either or both the alignment and addition can be performed by either a gaming console or server in a gaming session. The narrated video segment can be added to a player's library of video segments. The narrated video segment can be sent by the gaming console or server to a social media account of a game player or to another location.

The narration can be provided using one or more devices. For example, the gaming console can provide audio and video out to speakers and a monitor using an HDMI (High-Definition Multimedia Interface) or other output. Portions of a narration, such as audio and tactile effects, can be provided using a controller, headset, or other device connected to the gaming console.

The content that the narration and other enhancements can be added to can be a video segment. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

Various embodiments of the present invention can incorporate one or more of these and the other features described herein. A better understanding of the nature and advantages of the present invention can be gained by reference to the following detailed description and the accompanying drawings.

In the interest of clarity of explanation, the embodiments can be described in connection with a video game system including a gaming console and a server. However, the embodiments are not limited as such and can similarly apply to any other type of a computer system.

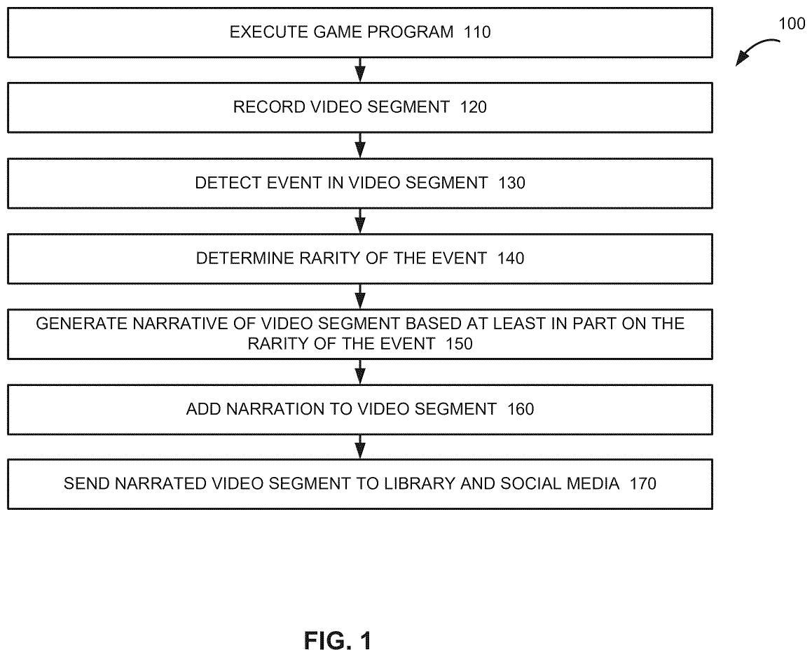

FIG. 1 is a flowchart illustrating the generation of a narration for a video game segment according to an embodiment of the present invention. This figure, as with the other included figures, is shown for illustrative purposes and does not limit either the embodiments of the present invention or the claims.

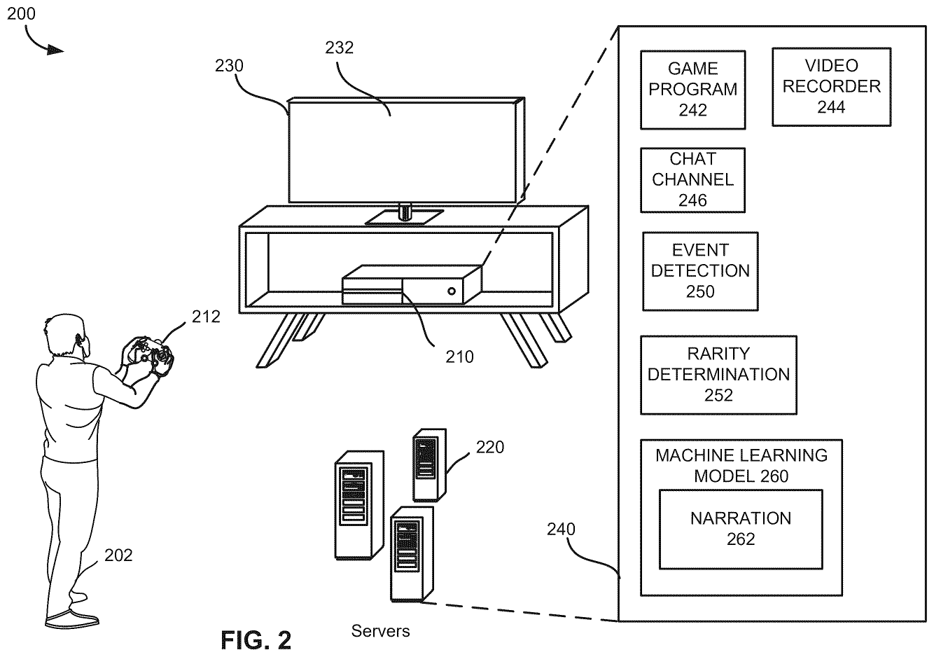

Flowchart 100 can be executed by components of a gaming system 200 (shown in FIG. 2.) Gaming system 200 can include a gaming console 210 and one or more servers 220 (both shown in FIG. 2.) Gaming system 200 can include or be partially or fully replaced by another types of computer system. In flowchart 100, gaming system 200 can record a video segment, detect one or more events in the video segment, determine a rarity or other aspect of one or more events, and generate a narrative based at least in part on the rarity or other aspect of one or more events. The narration can be combined with the video segment and stored in a library or provided to an associated social media account.

In act 110, a game program can be executed. The game program can be executed on the same electronic device that is being used to play the game program, or the game program can be executed and played on two separate devices. The game program can be executed on a gaming console, on a server, or other computing device. The gaming console can be a desktop gaming console, desktop computer, handheld device, portable computer, tablet computer, phone, or other computing device. The game program can be executed by reading data from a disc drive, a hard drive, SD storage card, non-transitory computer-readable storage media, or other storage device. The game program can be streamed from one or more servers through the cloud, such that the game program is played on a first electronic device, such as a desktop or handheld gaming console or other computing device, while the game program is executed on a server or other computing device. The game program can include one or more games, including one or more short games referred to as minigames. The game program can be executed with one or more players playing the game program in a game session.

In act 120, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 130, an event can be detected. The event can be one or one or more events that can be detected in a video segment. The event can be detected by a gaming console, a server, or other device. The event can be detected by a device on which the game program is being played, by a device that is executing the game program, or by another electronic computing device. What qualifies as an event can be highly context dependent. An event (as the term is used herein) can be an action that is of interest in the game session. Whether an action qualifies as an event of interest can depend on an identity of the game program, the experience of a player, the age of the player, the in-game circumstances, and other factors. An event can be an action that causes an addition or subtraction to a score of a player. An event can be an action that elicits a notable response from one or more players. An event can be an action that requires a player to provide several inputs to a controller or other input device (or devices) in short succession.

An event can be detected in various ways. For example, a gaming console or other electronic device executing a game program can detect car crashes, passes, spinouts, and other events in a racing game. In another example, a gaming console running a game program can detect how quickly or effortlessly a “boss” is defeated in a boss fight or how little damage a character sustained during a particularly difficult fight. This can be done natively by the game program, for example when allocating or deducting points, extra time, or other incentive or disincentive in the game session for various achievements and failures. Since these events are already being tracked by the game program, they can be provided as detected events along with the corresponding video segment to a server. That is, the events can be tagged and bookmarked in the video segment and provided to the server. A gaming console can further store a set of patterns that can be compared to patterns in the video segment. An event can be identified when an event that is at least similar to a pattern in the set of patterns occurs. The gaming console can also identify events by following a chat channel of a game session. An event can be identified when an action in a game session elicits an excited or other response from one or more players of the game.

In these and other embodiments of the present invention, a server or other electronic device can detect events. For example, a gaming console can provide a video segment with a recording from a chat channel to the server. The server can review the recording and detect events. An event can be identified when an action in a game session elicits an excited or other response from one or more players of the game. A server can further store a set of patterns that can be compared to patterns in the video segment. An event can be identified when an event that is at least similar to a pattern in the set of patterns occurs. The server can determine the presence of an event in the video segment using a machine learning model that has been trained to identify the presence of events in video segments of game sessions of the game program. In these and other embodiments of the present invention, the gaming console, the server, or other electronic device can detect events.

In act 140, a rarity of an event can be determined. An event can be given a rarity score or other indication. The rarity of an event can be determined in various ways. For example, a gaming console, server, or other electronic device executing a game program can award or deduct points, extra time, or provide other incentive or disincentive for the various events that occur in a game session as a native part of the game program. The game program can have a rarity score or other parameter for different events that can occur in a game session. This rarity score can be used in determining the magnitude of incentives and disincentives, or it can be separate. This information, such as incentives and disincentives, rarity scores, and other information, can be added to the corresponding video segment and provided to a server. The gaming console can further use other information to determine the rarity of an event. For example, when detecting the presence of an event using a chat channel, the gaming console can additionally determine a rarity score or indication based on the level of excitement or other response from elicited by one or more players of the game. In another example, the rarity score may be determined by certain attributes of in-game objects, such as rarity of the weapons or other “perks” used during the game, level of the in-game characters (characters at a higher level being more likely to execute difficult actions), and game level (high levels are more difficult and thus more likely to have rare events). In another example, the rarity score may also depend upon in-game upgrades, such as in-game power-ups and enhancements.

In these and other embodiments of the present invention, a server or other electronic device can determine the rarity of an event. For example, the server can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session. The sever can also monitor a chat channel for specific types of responses from the players of the game session. A rarity score or other indication can be assigned based on the level of excitement or other response from elicited by one or more players of the game.

In act 150, a narration of the video segment can be generated. The narration can be based at least in part on a rarity of an event as determined in act 140. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. Statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

The generation of the narration can utilize other information along with or instead of the rarity of events. For example, material from past game sessions, such as those that include a present game player, can be included. Other material from linked social media accounts, news stories that the present game player might be interested in can be included as part of the narration.

The narration can have a style. Various types of styles can be used, such as sarcasm, sports play-by-play, styles based on popular culture, and others. The style can be selected by a user, for example using a menu that is provided by the gaming console using a graphical user interface. The style can be based on previous selections made by the user. The style can be chosen by either the gaming console or a server based on the identity of the game program. The style can be chosen based on the rarity of one or more events in the game session being narrated. The style can be chosen based on an age of a player of the game session, the time or season of the year, or other factors. The style selection can be changed by a player and the narration can be regenerated.

The narration can be provided using one or more formats. For example, the narration can be one or more voices or other audio, text, graphical additions such as avatars or other graphical characters, or a combination of these. Graphical characters can point out playing errors in the video segment. Graphical characters can have a level of enthusiasm and interaction that reflects the rarity of events being described in the narration. The narration can include tactile effects. For example, a controller can vibrate when an explosion occurs.

The narration can include descriptions from one, two, three, or more than three virtual narrators. These virtual narrators can be in conversation with each other. The one or more virtual narrators can discuss the content of the video segment as well as other non-game related topics. For example, they can discuss news relating to topics that a game player is interested in. The narrative voices can be from an outside point of view, from an NPC, another player, an enemy in the game program, or other point of view.

Audio portions of the narration can be overlayed or they can replace music or other audio from the game session. Portions of a recording of a chat channel of the game session can be included as part of the narration. Music or other audio that is not from the game session can be added to highlight one or more events of the video segment. A new musical track can be generated and added to the video segment, where the musical track is tied to the events of the video segment or has a rhythm based on the events of the video segment. Video clips can be generated and added to the video segment. Video clips from other sources or other video segments can be added as part of the narration. The added audio and video clips can be pulled from popular culture, or they can be generated by a server using a machine learning model that has been trained to generate such audio and video clips.

In act 160, once the narration is generated, it can be aligned with and added to the video segment of the video session of the game program. The alignment can be done to ensure that narration description is timed to the event of the video segment. Either or both the alignment and addition can be performed by either a gaming console or server in a gaming session.

In act 170, the narrated video segment can be added to a player's library of video segments. The narrated video segment can be sent by the gaming console or server to a social media account of a game player or to another location.

When a narrated video clip is played back, the narration can be provided using one or more devices. For example, the gaming console can provide audio and video out to speakers and one or more monitors using HDMI or other outputs. Portions of a narration, such as sound and tactile effects, can be provided using a controller, headset, or other device connected to the gaming console.

Embodiments of the present invention can execute on various types of gaming or other computer systems. A first example might be considered a traditional gaming system, where a player in a game session of a game program can interact with a game controller connected to a gaming console. The gaming console can be coupled through a series of wired and wireless connections to a server. The server can be remote from the gaming console, for example in a different country, or the server can be near the gaming console. The sever can be a single server or it can be two or more servers. The gaming console can be a desktop console that is wirelessly connected to the controller. The gaming console can be a handheld device that has the controller built into or formed as part of the handheld device. A screen can be connected to the gaming console or it can be built into the gaming console. In a second, less traditional example, a player in a game session of a game program can interact with a tablet, portable computer, phone, desktop computer, or other electronic device. The electronic device can be coupled through a series of wired and wireless connections to a server. The server can be remote from the electronic device, for example in a different country, or the server can be near the gaming console. The sever can be a single server or it can be two or more servers. The electronic device can be wirelessly connected to a controller. The electronic device can be a handheld device that has the controller built into or formed as part of the handheld device. A screen can be connected to the electronic device or it can be built into the electronic device. An example of a gaming system is shown in the following figure.

FIG. 2 illustrates an example of a player interacting with an illustrative gaming system capable of generating narration for a recorded video game segment according to an embodiment of the present invention. This figure is representative of the first, more traditional example of a gaming system as outlined above. In the illustrated example, a player 202 can interact with gaming console 210 using controller 212. Gaming console can display game images on screen 232 of monitor 230. Gaming console 210 can share information with servers 220 via one or more paths comprising wired and wireless links, though in these and other embodiments of the present invention, gaming console 210 can be a standalone device without an internet connection. In the second, less traditional example above, controller 212 and gaming console 210 can be combined into a single device, such as a tablet, phone, portable computer, or other electronic device, though controller 212 can remain a separate component.

Program modules 240 can be allocated and executed on gaming console 210, servers 220, or other electronic devices in various ways. In various embodiments of the present invention, gaming console 210 can execute each or substantially all of the program modules 240, servers 220 can execute each or substantially all of the program modules 240, or responsibility for program modules 240 can be allocated between gaming console 210 or other electronic device, and servers 220.

In the illustrated first example, the game program 242 can be executed on gaming console 210 or servers 220. The video recorder 244 can be included in gaming console 210 or servers 220. For example, where game program 242 is a solo game executing on gaming console 210, the recording can be done on the gaming console 210, while where game program 242 is a multiplayer online game, servers 220 might be better suited to record a video segment. The same can be true of chat channel 246.

Event detection module 250 can be executed on gaming console 210 or servers 220. For example, the electronic device that executes game program 242 can allocated or deduct points, extra time, or provide other incentive or disincentive in the game session for various achievements and failures. Since these events are already being tracked by the game program, the same device can determine the events in a video segment. The gaming console can also identify events by following a chat channel of a game session. Event detection module 250 can determine an event has happened when an action in a game session elicits an excited or other response from one or more players of the game.

Once an event has been detected, it can be given a rarity score or other indication of rarity by rarity determination module 252. This can be done by the same electronic device that determines events, though it can be done by a different electronic device. For example, the electronic device that determines events by the allocation or deduction of points, extra time, or provides other incentive or disincentive, can determine an events rarity from the magnitude of the incentive or disincentive. In other examples, servers 220 can store a number of game sessions, including a present game session. The game sessions can be input to a machine learning model that has been trained to identify the rarity of events in video segments of game sessions of the game program. The machine learning model can provide a rarity score or other indication of the rarity of one or more events in the present game session. The sever can also monitor a chat channel for specific types of responses from the players of the game session. A rarity score or other indication can be assigned based on the level of excitement or other response from elicited by one or more players of the game.

Event detection and rarity determination can be executed by event detection module 250 and rarity determination module 252, respectively. In these and other embodiments, these can be executed using machine learning models 260. Machine learning models 260 can include a machine learning models 260 including narration machine learning model 262. Narration machine learning model 262 can execute on servers 220 or gaming console 210. An example of a module including a machine learning model 260 for generating a narration is illustrated in the following figure.

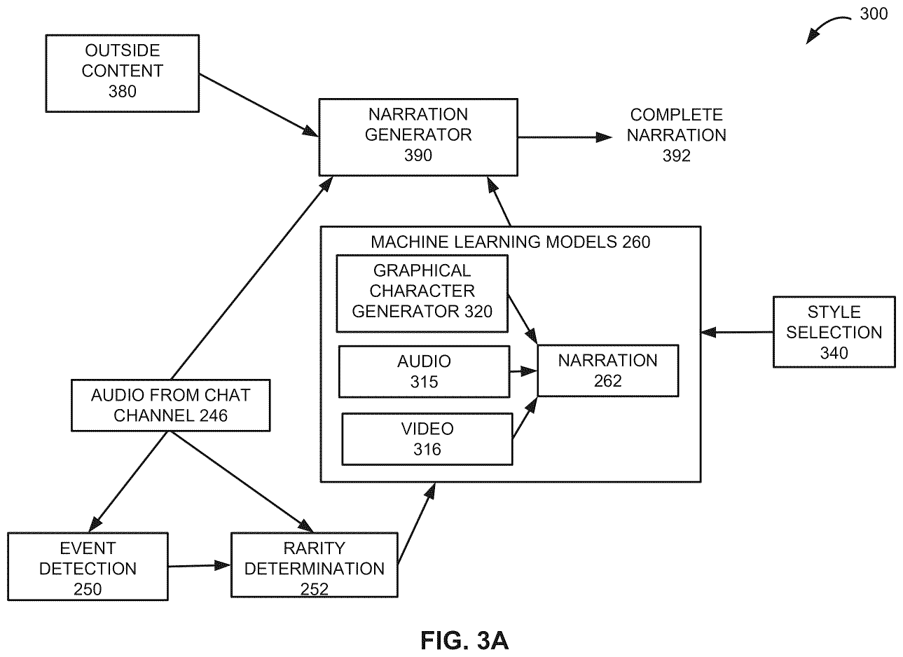

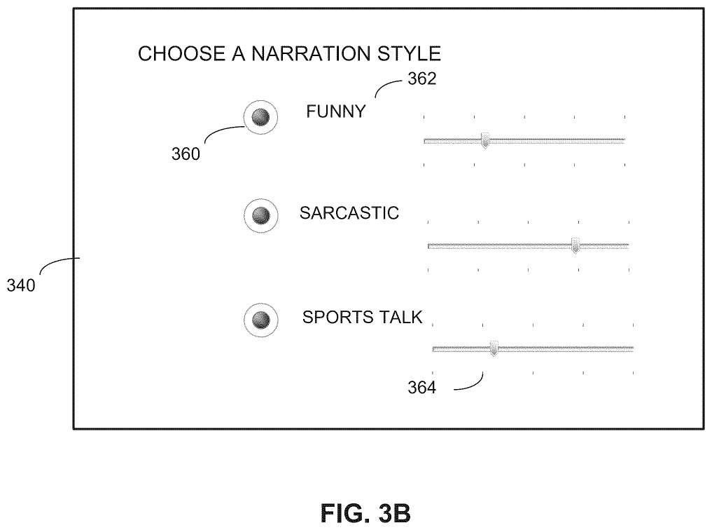

FIG. 3A illustrates various modules, models, and content that can be used when producing a narration for a video game segment, while FIG. 3B illustrates a graphical user interface for selecting a style of narration according to an embodiment of the present invention. Events can be detected by event detection module 250 and their rarity can be determined by rarity determination module 252. Input from chat channel 246 can be used both to detect an event and to determine its rarity. The complete narration 392 can be generated by narration generator 390. The complete narration 392 can be based at least in part on a rarity of an event as determined by rarity determination module 252. The narration can be generated for a video segment using events in the video segment and their corresponding rarity score or other rarity indication. The narration can be generated by a server using narration machine learning model 262 that has been trained to generate narrations of video segments of game sessions of the game program based at least in part on the rarity of an event. Statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

The generation of the narration can utilize other information provided by outside content 380 along with or instead of the rarity of events. Material from past game sessions, such as those that include a present game player, can be included. Outside content 380 from linked social media accounts, news stories that the present game player might be interested in can be included as part of the narration.

The narration can have a style. Various types of styles can be used, such as sarcasm, sports play-by-play, styles based on popular culture, and others. The style can be selected by a player, for example using a menu 340 that is provided by the gaming console using a graphical user interface. The style can be based on previous selections made by the player. The style can be chosen by either the gaming console or a server based on the identity of the game program. The style can be chosen based on the rarity of one or more events in the game session being narrated. The style can be chosen based on an age of a player of the game session, the time or season of the year, or other factors. The style selection can be changed by a player and the narration can be regenerated.

The narration can be provided using one or more formats. For example, the narration can be one or more voices or other audio, text, graphical additions such as avatars or other graphical characters, or a combination of these. One or more narrative voices can be generated by audio machine learning model 315. Graphical characters can be generated by graphical character generator 320, and these graphical characters can point out or describe playing errors in the video segment. Graphical characters can have a level of enthusiasm and interaction that reflects the rarity of events being described in the narration. The narration can include video generated by video machine learning model 316 as well. The narration can include tactile effects. For example, a controller can vibrate when an explosion occurs.

The narration can include descriptions from one, two, three, or more than three virtual narrators generated by audio machine learning model 315. These virtual narrators can be in conversation with each other. The one or more virtual narrators can discuss the content of the video segment as well as other non-game related topics. For example, they can discuss news relating to topics that a game player is interested in, as provided by outside content 380. The narrative voices can be from an outside point of view, from an NPC, another player, an enemy in the game program, or other point of view.

Audio portions of the narration generated by audio machine learning model 315 can be overlayed or they can replace music or other audio from the game session. Portions of a recording of chat channel 246 of the game session can be included as part of the narration. Music or other audio that is not from the game session can be generated by audio machine learning model 315 and added to highlight one or more events of the video segment. A new musical track can be generated and added to the video segment, where the musical track is tied to the events of the video segment or has a rhythm based on the events of the video segment. Video clips can be generated by video machine learning model 316 and added to the video segment. Video clips from outside content 380 or other video segments can be added as part of the narration. The added audio and video clips can be pulled from popular culture, or they can be generated by audio machine learning model 315 and video machine learning model 316 that have been trained to generate such audio and video clips.

FIG. 3B illustrates a menu or list of options for a narration style to be used when generating the narration. Menu 340 can be presented to a player using a graphical user interface. The menu can list styles 362 that can be used, along with radio buttons 360 or other appropriate mechanism for making a selection. The menu can further include one or more corresponding sliders 364 to allow a user to determine the degree to which a style is applied.

These modules and models can be used in various ways to generate narrations for video segments. In a first example, a player in a racing game program can pass four cars in a single turn. Event detection module 250 in game program can award a high amount of points for this maneuver event. From this award, it can be determined by rarity determination module 252 that passing these cars is a rare event. A descriptive narration can be generated that describes the action by narration machine learning model 262. For example, the narration can be from the point of view of a driver being passed talking to their pit crew. A graphical character representing a pit crew boss can appear on the screen waving their arms in anger, as generated by graphical character generator 320. The style of narration can be selected by the player using a menu 340, such as the menu shown in FIG. 3A. The server might know that the players favorite baseball team has recently passed four teams in the standings. Audio and visual content related to the change in standings, shown here as outside content 380, can be retrieved over the internet or from local storage. Audio and visual content can be generated by audio machine learning model 315 and video machine learning model 316 and added to the narration. These various elements can be combined into a complete narration 392 by narration generator 390. Complete narration 392 can be enthusiastic (aside from the angry pit boss) to reflect the rarity of the event. In these and other embodiments of the present invention, these and other elements can be used to generate complete narration 392, and one or more of the elements described here can be omitted.

In a second example, a player can use controller 212 to inadvertently ice skate their avatar off a cliff and into chilly waters in a repetitive manner. This can elicit a complete narration 392 that is sarcastic to be generated. Here the game generator can determine that this has happened ten times in a row. Even if points are not deducted, it can be determined that an event has happened by event detection module 250. Rarity determination module 252 can determine that this does not happen often. Graphical characters can be generated by graphical character generator 320, and audio and visual content can be generated by audio machine learning model 315 and video machine learning model 316 and added to the narration generated by narration machine learning model 262. In this case, the default style selection from menu 340 can be sarcastic. Outside content 380, perhaps including professional skaters falling, can be added. These various elements can be combined by narration generator 390, which can provide the complete narration 392. In these and other embodiments of the present invention, these and other elements can be used to generate complete narration 392, and one or more of the elements described here can be omitted.

The steps used to generate these narrations can be performed by different devices in these and other embodiments of the present invention. Examples of the operation of a gaming console is shown in the following two figures.

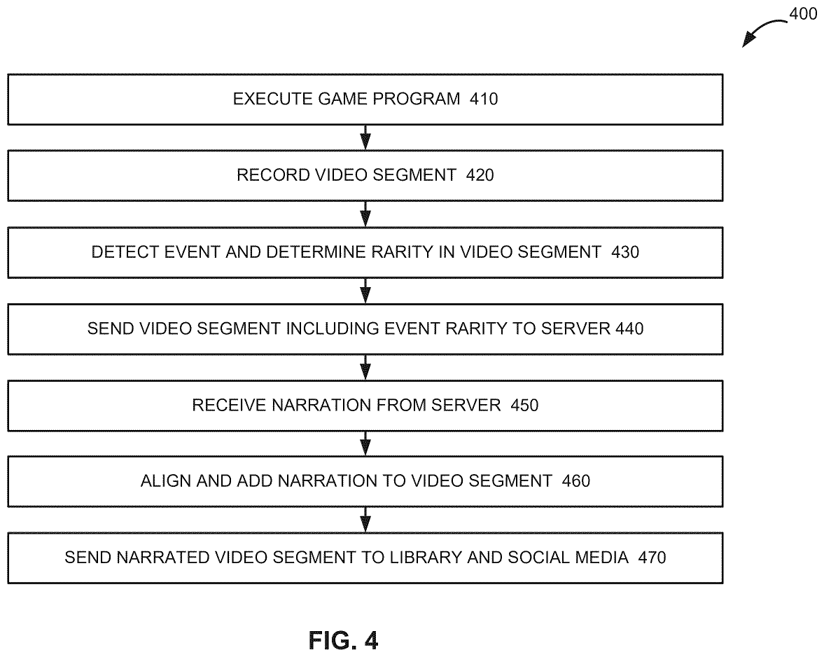

FIG. 4 is a flowchart illustrating the operation of a gaming console according to an embodiment of the present invention. In flowchart 400, in act 410, a game program can be executed, for example on gaming console 210 (shown in FIG. 2.) The game program can be executed on the same gaming console that is being used to play the game program, or the game program can be executed and played on two separate devices. The gaming console can be a desktop gaming console, handheld device, or other type of gaming console. The game program can be executed by reading data from a disc drive, a hard drive, SD storage card, non-transitory computer-readable storage media, or other storage device. The game program can include one or more games, including one or more short games referred to as minigames. The game program can be executed with one or more players playing the game in a game session.

In act 420, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 430, an event can be detected. The event can be one or one or more events that can be detected in a video segment. The event can be detected by the gaming console. The event can be detected by the device on which the game program is being played, by a device that is executing the game program, or by another electronic computing device. An event can be detected in various ways. For example, a gaming console executing a game program can detect car crashes, passes, spinouts, and other events in a racing game. In another example, a gaming console running a game program can detect how quickly or effortlessly a “boss” is defeated in a boss fight or how little damage a character sustained during a particularly difficult fight. This can be done natively by the game program, for example when allocating or deducting points, extra time, or other incentive or disincentive in the game session for various achievements and failures. Since these events are already being tracked by the game program, they can be provided as detected events along with the corresponding video segment to a server. That is, the events can be tagged and bookmarked in the video segment and provided to the server. The gaming console can also identify events by following a chat channel of a game session. An event can be identified when an action in a game session elicits an excited or other response from one or more players of the game.

A gaming console can further store a set of patterns that can be compared to patterns in the video segment. An event can be identified when an event that is at least similar to a pattern in the set of patterns occurs. A gaming console can determine the presence of an event in the video segment using a machine learning model that has been trained to identify the presence of events in video segments of game sessions of the game program.

Also in act 430, a rarity of an event can be determined. An event can be given a rarity score or other indication. The rarity of an event can be determined in various ways. The gaming console executing a game program can award or deduct points, extra time, or provide other incentive or disincentive for the various events that occur in a game session as a native part of the game program. The game program can have a rarity score or other parameter for different events that can occur in a game session. This rarity score can be used in determining the magnitude of incentives and disincentives, or it can be separate. This information, such as incentives and disincentives, rarity scores, and other information, can be added and bookmarked to the corresponding video segment and provided to a server. The gaming console can further use other information to determine the rarity of an event. For example, when detecting the presence of an event using a chat channel, the gaming console can additionally determine a rarity score or indication based on the level of excitement or other response from elicited by one or more players of the game. In another example, the rarity score may be determined by certain attributes of in-game objects, such as rarity of the weapons or other “perks” used during the game, level of the in-game characters (characters at a higher level being more likely to execute difficult actions), and game level (high levels are more difficult and thus more likely to have rare events). In another example, the rarity score may also depend upon in-game upgrades, such as in-game power-ups and enhancements.

In these and other embodiments of the present invention, a gaming console can determine the rarity of an event using a machine learning model. For example, the gaming console can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session.

In act 440, the video segment including the event and an indication or score of its rarity can be provide to a server. In act 450, a narration of the video segment can be generated. The narration can be based at least in part on a rarity of an event as determined in act 430. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. That is, statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

In act 460, once the narration is generated, it can be aligned with and added to the video segment of the video session of the game program. The alignment can be done to ensure that narration description is timed to the event of the video segment. Either or both the alignment and addition can be performed by the gaming console.

In act 470, the narrated video segment can be added to a player's library of video segments. The narrated video segment can be sent by the gaming console or server to a social media account of a game player or to another location.

The narration can have a style. Various types of styles can be used, such as sarcasm, sports play-by-play, styles based on popular culture, and others. The style can be selected by a user, for example using a menu that is provided by the gaming console using a graphical user interface. When such a menu is used, the styles available on the menu can be limited based on an age of a player of the game session. The styles available on the menu can be limited for those that have selected to have limited narration styles available. The style can be based on previous selections made by the user. The style can instead be chosen by either the gaming console or a server. The style can be selected by either the gaming console or the server based on the identity of the game program. The style can be chosen based on the rarity of one or more events in the game session being narrated. The style can be chosen based on an age of a player of the game session, the time or season of the year, or other factors. For example, the styles that can be selected can be limited by the gaming console or server for minors or those who have chosen to have limited style options available. Following the generation of a narration, the style selection can be changed by a player and the narration can be regenerated. An example of a flowchart of the operation of a gaming console including a selection of a style is shown in the following figure.

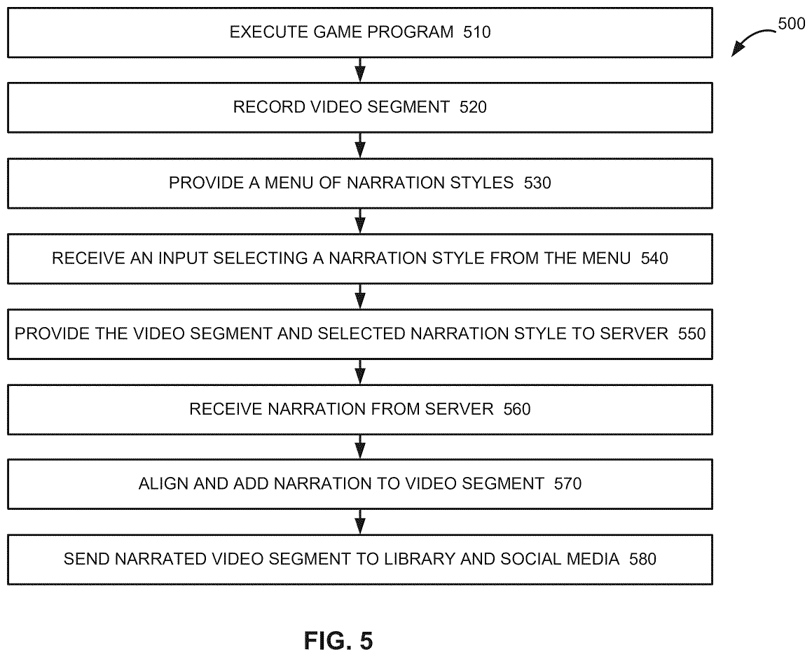

FIG. 5 is a flowchart illustrating the operation of a gaming console according to an embodiment of the present invention. In act 510 of flowchart 500, a game program can be executed, for example on gaming console 210 (shown in FIG. 2.) The game program can be executed on the same gaming console that is being used to play the game program, or the game program can be executed and played on two separate devices. The gaming console can be a desktop gaming console, handheld device, or other type of gaming console. The game program can be executed by reading data from a disc drive, a hard drive, SD storage card, non-transitory computer-readable storage media, or other storage device. The game program can include one or more games, including one or more short games referred to as minigames. The game program can be executed with one or more players playing the game program in a game session.

In act 520, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 530, the gaming console can provide a player with a menu or list of options for a narration style to be used when generating the narration. The menu can be presented using a graphical user interface. The menu can list styles that can be used, along with radio buttons or other appropriate mechanism for making a selection. The menu can further include one or more corresponding sliders to allow a user to determine the degree to which a style is applied, as shown in FIG. 3B.

In act 540, the gaming console can receive the narration selection and other inputs from a player. In act 550, the video segment and selected narration style can be provided to a server. In act 560, a narration of the video segment can be received from the server. The narration can be based at least in part on a rarity of an event as determined in act 530. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. Statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

In act 570, once the narration is generated, it can be aligned with and added to the video segment of the video session of the game program. The alignment can be done to ensure that narration description is timed to the event of the video segment. Either or both the alignment and addition can be performed by the gaming console.

In act 580, the narrated video segment can be added to a player's library of video segments. The narrated video segment can be sent by the gaming console or server to a social media account of a game player or to another location.

Again, the steps used to generate these narrations can be performed by different devices in these and other embodiments of the present invention. An example of the operation of a server is shown in the following figure.

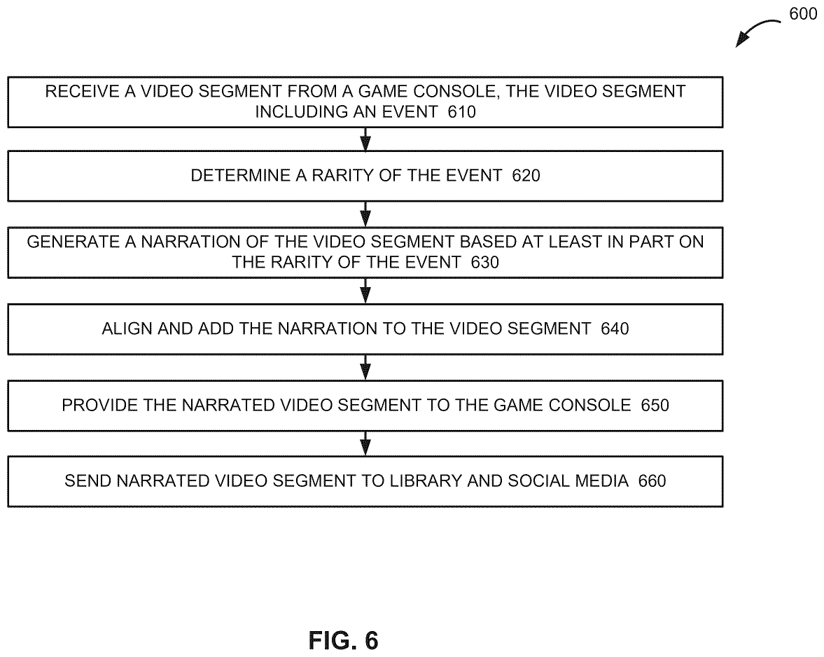

FIG. 6 is a flowchart illustrating the operation of a server according to an embodiment of the present invention. In act 610 of flowchart 600, a video segment including an event can be received by server 220 (shown in FIG. 2.) In act 620, a rarity of the event can be determined by the server. For example, the server can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session. The sever can also monitor a chat channel for specific types of responses from the players of the game session. A rarity score or other indication can be assigned based on the level of excitement or other response from elicited by one or more players of the game.

In act 630, a narration of the video segment can be generated. The narration can be based at least in part on a rarity of an event as determined in act 620. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. That is, statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

The generation of the narration can utilize other information along with or instead of the rarity of events. For example, material from past game sessions, such as those that include a present game player, can be included. Other material from linked social media accounts, news stories that the present game player might be interested in can be included as part of the narration.

The narration can have a style. Various types of styles can be used, such as sarcasm, sports play-by-play, styles based on popular culture, and others. The style can be selected by a user, for example using a menu that is provided by the gaming console using a graphical user interface. The style can be based on previous selections made by the user. The style can be chosen by either the gaming console or a server based on the identity of the game program. The style can be chosen based on the rarity of one or more events in the game session being narrated. The style can be chosen based on an age of a player of the game session, the time or season of the year, or other factors. The style selection can be changed by a player and the narration can be regenerated.

The narration can be provided using one or more formats. For example, the narration can be one or more voices or other audio, text, graphical additions such as avatars or other graphical characters, or a combination of these. For example, graphical characters can point out playing errors in the video segment. Graphical characters can have a level of enthusiasm and interaction that reflects the rarity of events being described in the narration. The narration can include tactile effects. For example, a controller can vibrate when an explosion occurs.

The narration can include descriptions from one, two, three, or more than three virtual narrators. These virtual narrators can be in conversation with each other. The one or more virtual narrators can discuss the content of the video segment as well as other non-game related topics. For example, they can discuss news relating to topics that a game player is interested in. The narrative voices can be from an outside point of view, from an NPC, another player, an enemy in the game program, or other point of view.

Audio portions of the narration can be overlayed or they can replace music or other audio from the game session. Portions of a recording of a chat channel of the game session can be included as part of the narration. Music or other audio that is not from the game session can be added to highlight one or more events of the video segment. A new musical track can be generated and added to the video segment, where the musical track is tied to the events of the video segment or has a rhythm based on the events of the video segment. Video clips can be generated and added to the video segment. Video clips from other sources or other video segments can be added as part of the narration. The added audio and video clips can be pulled from popular culture, or they can be generated by a server using a machine learning model that has been trained to generate such audio and video clips.

In act 640, once the narration is generated, it can be aligned with and added to the video segment of the video session of the game program. The alignment can be done to ensure that narration description is timed to the event of the video segment. Either or both the alignment and addition can be performed by either a gaming console or server in a gaming session. Alternatively, the narration can be provided to the gaming console, which can then align and add it to the video segment. This can reduce bandwidth consumption by not transferring the video segment through a network more than necessary. The narrated video segment can be provided to the gaming console in act 650 and uploaded to a player's library of video segments. The narrated video segment can be sent by the gaming console or server to a social media account of a game player or to another location in act 660.

The various acts described here can be performed solely or primarily using gaming console 210. In some embodiments the narration generation is done using a server. In other embodiments, the rarity determination and narration generation are done using a server. In other embodiments, the event detection, rarity determination, and narration generation are done using a server. In other embodiments, some or all of these various acts are done using a server. Examples where these tasks are shared by a gaming console and a server are shown in the following figures.

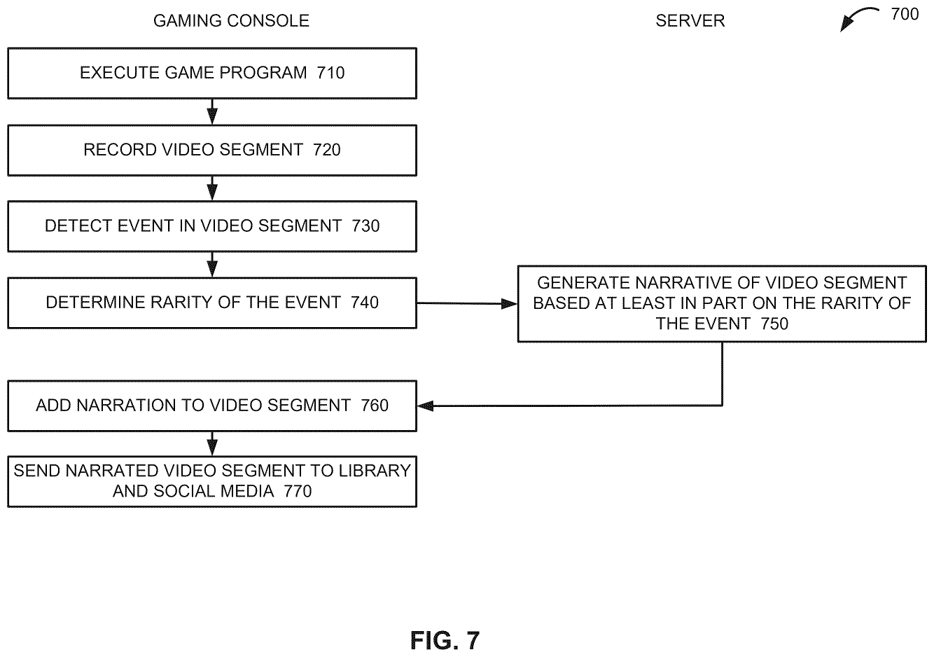

FIG. 7 is a flowchart illustrating the sharing of tasks between a gaming console and a server according to an embodiment of the present invention. In flowchart 700, act 710, a game program can be executed, for example on gaming console 210 (shown in FIG. 2.) The game program can be executed on the same gaming console that is being used to play the game program, or the game program can be executed and played on two separate devices. The gaming console can be a desktop gaming console, handheld device, or other type of gaming console. The game program can be executed by reading data from a disc drive, a hard drive, SD storage card, non-transitory computer-readable storage media, or other storage device. The game program can include one or more games, including one or more short games referred to as minigames. The game program can be executed with one or more players playing the game program in a game session.

In act 720, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 730, an event can be detected by the gaming console. The event can be one or one or more events that can be detected in a video segment. An event can be detected in various ways. For example, a gaming console executing a game program can detect car crashes, passes, spinouts, and other events in a racing game. In another example, a gaming console running a game program can detect how quickly or effortlessly a “boss” is defeated in a boss fight or how little damage a character sustained during a particularly difficult fight. This can be done natively by the game program, for example when allocating or deducting points, extra time, or other incentive or disincentive in the game session for various achievements and failures. Since these events are already being tracked by the game program, they can be provided as detected events along with the corresponding video segment to a server. That is, the events can be tagged and bookmarked in the video segment and provided to the server. The gaming console can also identify events by following a chat channel of a game session. An event can be identified when an action in a game session elicits an excited or other response from one or more players of the game.

A gaming console can also or instead store a set of patterns that can be compared to patterns in the video segment. An event can be identified when an event that is at least similar to a pattern in the set of patterns occurs. A gaming console can determine the presence of an event in the video segment using a machine learning model that has been trained to identify the presence of events in video segments of game sessions of the game program.

In act 740, the gaming console can determine a rarity of the event. The event can be given a rarity score or other indication. The rarity of an event can be determined in various ways. The gaming console executing a game program can award or deduct points, extra time, or provide other incentive or disincentive for the various events that occur in a game session as a native part of the game program. The game program can have a rarity score or other parameter for different events that can occur in a game session. This rarity score can be used in determining the magnitude of incentives and disincentives, or it can be separate. This information, such as incentives and disincentives, rarity scores, and other information, can be added and bookmarked to the corresponding video segment and provided to a server. The gaming console can further use other information to determine the rarity of an event. For example, when detecting the presence of an event using a chat channel, the gaming console can additionally determine a rarity score or indication based on the level of excitement or other response from elicited by one or more players of the game. In another example, the rarity score may be determined by certain attributes of in-game objects, such as rarity of the weapons or other “perks” used during the game, level of the in-game characters (characters at a higher level being more likely to execute difficult actions), and game level (high levels are more difficult and thus more likely to have rare events). In another example, the rarity score may also depend upon in-game upgrades, such as in-game power-ups and enhancements.

In these and other embodiments of the present invention, a gaming console can determine the rarity of an event using a machine learning model. For example, the gaming console can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session.

In act 750, a narration of the video segment can be generated. The narration can be based at least in part on a rarity of an event as determined in act 740. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. That is, statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

In act 760, once the narration is generated, it can be aligned with and added to the video segment of the video session of the game program by the gaming console. The alignment can be done to ensure that narration description is timed to the event of the video segment. Either or both the alignment and addition can be performed by the gaming console as shown here, or by a server.

In act 770, the narrated video segment can be added to a player's library of video segments. The narrated video segment can be sent by the gaming console or server to a social media account of a game player or to another location.

In this example, the gaming console is responsible for the various tasks aside from narration generation in act 750. In these and other embodiments of the present invention, the gaming console can include the machine learning model 260 and some or all of the functions shown in the narration generating apparatus of FIG. 3A such that the gaming console can execute act 750.

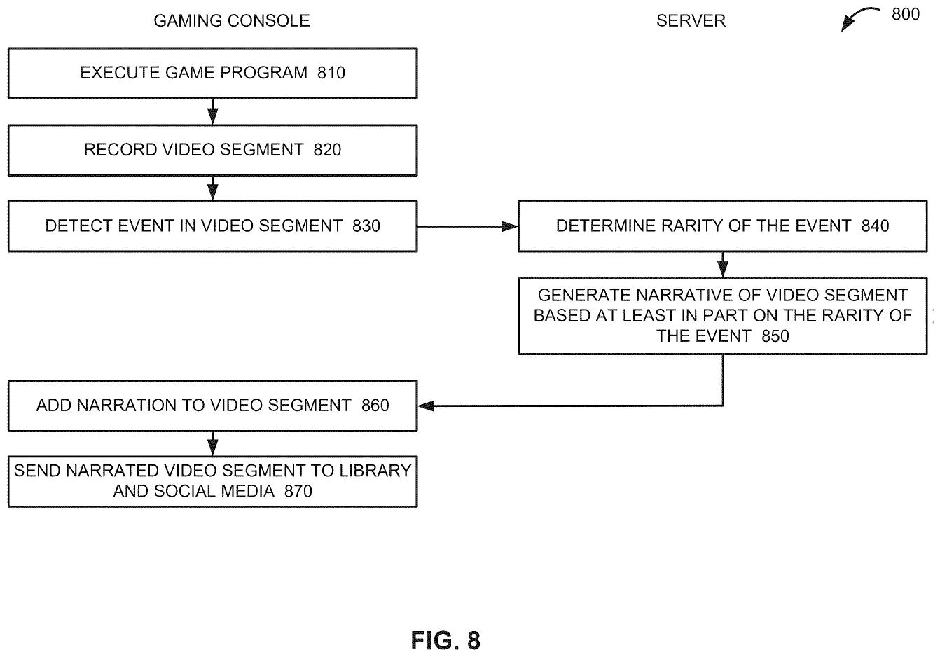

FIG. 8 is another flowchart illustrating the sharing of tasks between a gaming console and a server according to an embodiment of the present invention. In flowchart 800, act 810, a game program can be executed, for example on gaming console 210 (shown in FIG. 2.) The game program can be executed on the same gaming console that is being used to play the game program, or the game program can be executed and played on two separate devices. The gaming console can be a desktop gaming console, handheld device, or other type of gaming console. The game program can be executed by reading data from a disc drive, a hard drive, SD storage card, non-transitory computer-readable storage media, or other storage device. The game program can include one or more games, including one or more short games referred to as minigames. The game program can be executed with one or more players playing the game program in a game session.

In act 820, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 830, an event can be detected by the gaming console. The event can be one or one or more events that can be detected in a video segment. An event can be detected in various ways. For example, a gaming console executing a game program can detect car crashes, passes, spinouts, and other events in a racing game. In another example, a gaming console running a game program can detect how quickly or effortlessly a “boss” is defeated in a boss fight or how little damage a character sustained during a particularly difficult fight. This can be done natively by the game program, for example when allocating or deducting points, extra time, or other incentive or disincentive in the game session for various achievements and failures. Since these events are already being tracked by the game program, they can be provided as detected events along with the corresponding video segment to a server. That is, the events can be tagged and bookmarked in the video segment and provided to the server. The gaming console can also identify events by following a chat channel of a game session. An event can be identified when an action in a game session elicits an excited or other response from one or more players of the game.

A gaming console can also or instead store a set of patterns that can be compared to patterns in the video segment. An event can be identified when an event that is at least similar to a pattern in the set of patterns occurs. A gaming console can determine the presence of an event in the video segment using a machine learning model that has been trained to identify the presence of events in video segments of game sessions of the game program.

In act 840, the server can determine a rarity of the event. The event can be given a rarity score or other indication. The server can determine the rarity of an event using a machine learning model. For example, the server can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session.

In act 850, a narration of the video segment can be generated by a server. The narration can be based at least in part on a rarity of an event as determined in act 840. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. Statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

In act 860, once the narration is generated, it can be aligned with and added to the video segment of the video session of the game program by the gaming console. The alignment can be done to ensure that narration description is timed to the event of the video segment. Either or both the alignment and addition can be performed by the gaming console, as shown here, or by a server.

In act 870, the narrated video segment can be added to a player's library of video segments. The narrated video segment can be sent by the gaming console or server to a social media account of a game player or to another location.

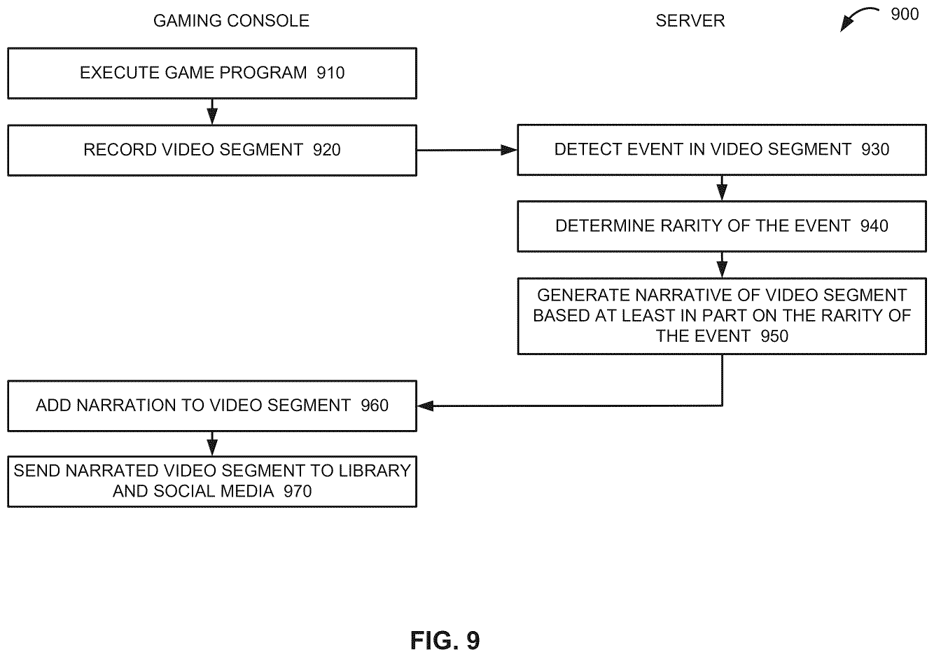

FIG. 9 is another flowchart illustrating the sharing of tasks between a gaming console and a server according to an embodiment of the present invention. In flowchart 900, act 910, a game program can be executed, for example on gaming console 210 (shown in FIG. 2.) The game program can be executed on the same gaming console that is being used to play the game program, or the game program can be executed and played on two separate devices. The gaming console can be a desktop gaming console, handheld device, or other type of gaming console. The game program can be executed by reading data from a disc drive, a hard drive, SD storage card, non-transitory computer-readable storage media, or other storage device. The game program can include one or more games, including one or more short games referred to as minigames. The game program can be executed with one or more players playing the game in a game session.

In act 920, a video segment can be recorded. The video segment can be recorded by the electronic device that the game is being played on, for example a desktop or handheld gaming console or other electronic device. The video segment can be recorded by the electronic device that is executing the game program. The video segment can have different lengths. For example, the video segment can be a recording of an entire game session of a game program. The video segment can be a portion or a collection of portions of a game session. The video segment can be a highlight or a collection of highlights of a game session. The video segment can be recorded from different points of view. For example, the video segment can be recorded as seen by a player. The video segment can be recorded as seen from a third party point of view. The video segment can be recorded from an NPC, another player in the game session, an enemy in the game session, or from another point of view.

In act 930, an event can be detected by a server. The event can be one or one or more events that can be detected in a video segment. The server can review the recording and detect events. An event can be identified when an action in a game session elicits an excited or other response from one or more players of the game. A server can further store a set of patterns that can be compared to patterns in the video segment. An event can be identified when an event that is at least similar to a pattern in the set of patterns occurs. The server can determine the presence of an event in the video segment using a machine learning model that has been trained to identify the presence of events in video segments of game sessions of the game program. In these and other embodiments of the present invention, the gaming console, the server, or other electronic device can detect events.

In act 940, the server can determine a rarity of the event. The event can be given a rarity score or other indication. A server can determine the rarity of an event using a machine learning model. For example, the server can store a number of game sessions, including a present game session for which a narration is being generated. The game sessions can be input to a machine learning model that has been trained to identify the rarity of events in video segments of game sessions of the game program. The machine learning model can provide a rarity score or other indication of the rarity of one or more events in the present game session.

In act 950, a narration of the video segment can be generated by a server. The narration can be based at least in part on a rarity of an event as determined in act 940. That is, the narration can be generated for a video segment using events in the video segment and their corresponding rarity score or other rarity indication. The narration can be generated by a server using a machine learning model that has been trained to generate narrations of video segments of game sessions of the game program based at least in part on the rarity of an event. That is, statistically rare events can be highlighted in the narration. The narration can have an increased level of enthusiasm and detail for events that is proportional to the rarity of the event be described. The tone, excitement level, and other aspects of the narration can track the events in the video segment being narrated. Rarer and more exciting events can elicit appropriately enthusiastic responses from the narration.

In act 960, once the narration is generated, it can be aligned with and added to the video segment of the video session of the game program by the gaming console. The alignment can be done to ensure that narration description is timed to the event of the video segment. Either or both the alignment and addition can be performed by the gaming console as shown here, of by a server.

In act 970, the narrated video segment can be added to a player's library of video segments. The narrated video segment can be sent by the gaming console or server to a social media account of a game player or to another location.

In these and other embodiments of the present invention, some or all of the activities shown as being performed by a gaming console can instead be done with a server. For example, the game program can be executed and a video segment can be recorded by the server. That is, acts 910 and 920 can be executed by the server. Further, the combining of the narration and video segments, and the sending of the narrated video segment to a library and social media accounts can be done by the server. That is, acts 960 and 970 can be executed by the server.

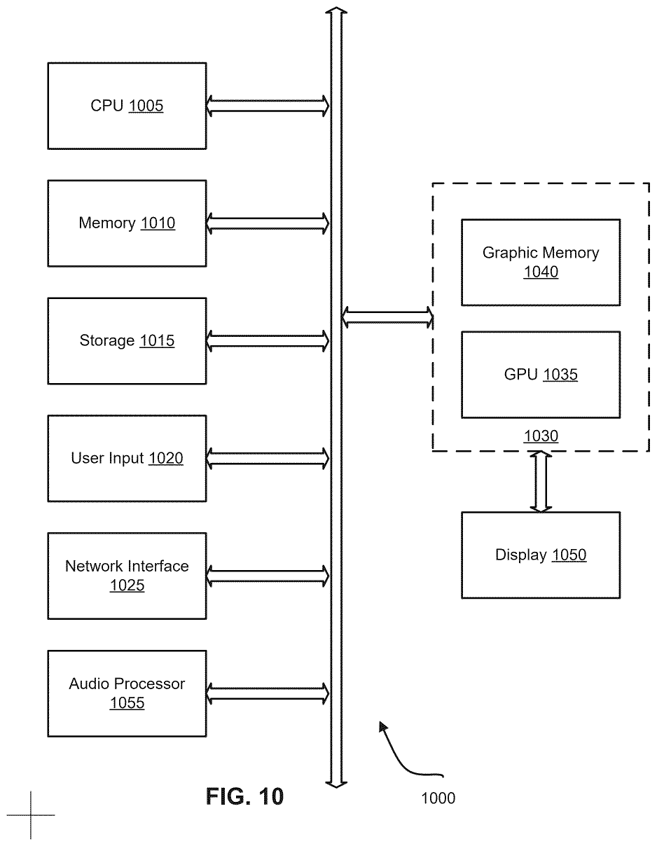

FIG. 10 illustrates an example of a computer system 1000 suitable for implementing techniques of the present disclosure, according to embodiments of the present disclosure. The computer system 1000 represents, for example, a user device (e.g., a touchscreen device or any other device described herein, above), a video game system, a backend set of servers, or other types of a computer system. The computer system 1000 includes a central processing unit (CPU) 1005 for running software applications and optionally an operating system. The CPU 1005 can be made up of one or more homogeneous or heterogeneous processing cores. Memory 1010 stores applications and data for use by the CPU 1005 (including possible any of the AI models and any program codes of applications described herein above). Storage 1015 provides non-volatile storage and other computer readable media for applications and data and can include fixed disk drives, removable disk drives, flash memory devices, and CD-ROM, DVD-ROM, Blu-ray, HD-DVD, or other optical storage devices, as well as signal transmission and storage media (and can store any of the training data and/or user data described herein above). User input devices 1020 communicate user inputs from one or more users to the computer system 1000, examples of which can include keyboards, mice, joysticks, touch pads, touch screens, still or video cameras, and/or microphones. Network interface 1025 allows the computer system 1000 to communicate with other computer systems (including ones hosting any of the AI models described herein) via an electronic communications network and can include wired or wireless communication over local area networks and wide area networks such as the Internet. An audio processor 1055 is adapted to generate analog or digital audio output from instructions and/or data provided by the CPU 1005, memory 1010, and/or storage 1015. The components of computer system 1000, including the CPU 1005, memory 1010, data storage 1015, user input devices 1020, network interface 1025, and audio processor 1055 are connected via one or more data buses 1060.

A graphics subsystem 1030 is further connected with the data bus 1060 and the components of the computer system 1000. The graphics subsystem 1030 includes a graphics processing unit (GPU) 1035 and graphics memory 1040. The graphics memory 1040 includes a display memory (e.g., a frame buffer) used for storing pixel data for each pixel of an output image. The graphics memory 1040 can be integrated in the same device as the GPU 1035, connected as a separate device with the GPU 1035, and/or implemented within the memory 1010. Pixel data can be provided to the graphics memory 1040 directly from the CPU 1005. Alternatively, the CPU 1005 provides the GPU 1035 with data and/or instructions defining the desired output images, from which the GPU 1035 generates the pixel data of one or more output images. The data and/or instructions defining the desired output images can be stored in the memory 1010 and/or graphics memory 1040. In an embodiment, the GPU 1035 includes 3D rendering capabilities for generating pixel data for output images from instructions and data defining the geometry, lighting, shading, texturing, motion, and/or camera parameters for a scene. The GPU 1035 can further include one or more programmable execution units capable of executing shader programs.

The graphics subsystem 1030 periodically outputs pixel data for an image from the graphics memory 1040 to be displayed on the display device 1050. The display device 1050 can be any device capable of displaying visual information in response to a signal from the computer system 1000, including CRT, LCD, plasma, and OLED displays. The computer system 1000 can provide the display device 1050 with an analog or digital signal.

In accordance with various embodiments, the CPU 1005 is one or more general-purpose microprocessors having one or more processing cores. Further embodiments can be implemented using one or more CPUs 1005 with microprocessor architectures specifically adapted for highly parallel and computationally intensive applications, such as media and interactive entertainment applications.

The components of a system can be connected via a network, which can be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network can include both wired and wireless connections, including optical links. Many other examples are possible and apparent to those skilled in the art in light of this disclosure. In the discussion herein, a network can or cannot be noted specifically.

Computer programs incorporating features of the present invention that can be implemented using program code can be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.). Computer readable media encoded with the program code can include an internal storage medium of a compatible electronic device and/or external storage media readable by the electronic device that can execute the code. In some instances, program code can be supplied to the electronic device via Internet download or other transmission paths.

In the foregoing specification, the invention is described with reference to specific embodiments thereof, but those skilled in the art will recognize that the invention is not limited thereto. Various features and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments can omit, substitute, or add various procedures or components as appropriate. For instance, it should be appreciated that, in alternative embodiments, the methods can be performed in an order different from that described, and that various steps can be added, omitted, or combined. Also, features described with respect to certain embodiments can be combined in various other embodiments. Different aspects and elements of the embodiments can be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments can be practiced without these specific details. For example, well-known circuits, processes, algorithms, structures, and techniques have been shown without unnecessary detail in order to avoid obscuring the embodiments.

Also, it is noted that the embodiments can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure.

Moreover, as disclosed herein, the term “memory” or “memory unit” can represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments can be implemented by hardware, software, firmware, middleware, microcode, hardware description languages, or any combination thereof. When implemented in software, firmware, middleware, or microcode, the program code or code segments to perform the necessary tasks can be stored in a computer-readable medium such as a storage medium. Processors can perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents can be used without departing from the spirit of the invention. For example, the above elements can merely be a component of a larger system, wherein other rules can take precedence over or otherwise modify the application of the invention. Also, a number of steps can be undertaken before, during, or after the above elements are considered. Accordingly, the above description should not be taken as limiting the scope of the invention.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method of operating a gaming console, the method comprising:
executing a game program;
recording a video segment of a game session of the game program, the game session including an event;
providing the video segment including the event to a server;
receiving a narration of the video segment from the server, wherein the narration is based at least in part on a rarity of the event; and
adding the narration to the video segment of the game session.

2. The method of claim 1 wherein the rarity of the event is determined using a chat channel used by players in the game session.

3. The method of claim 1 wherein the rarity of the event is determined by the server using a first machine learning model that has been trained to identify the rarity of events in video segments of game sessions of the game program.

4. The method of claim 3 wherein the narration is generated by the server using a second machine learning model that has been trained to generate narrations of video segments of game sessions of the game program based at least in part on the rarity of an event.

5. The method of claim 4 wherein the video segment is selected at least in part on the presence of the event.

6. The method of claim 4 wherein the narration is descriptive.

7. The method of claim 4 wherein the narration includes at least one of audio data, chat data, or image data of one or more players playing the game program.

8. The method of claim 4 wherein the narration has a style.

9. The method of claim 8 wherein the narration style is selected from a menu.

10. A method of operating a gaming console, the method comprising:
executing a game program;
recording a video segment of a game session of the game program;
providing the video segment to a server;
receiving a narration of the video segment from the server, the narration having a style, wherein the narration is based at least in part on the narration style; and
adding the narration to the video segment of the game session.

11. The method of claim 10 wherein the narration style is based at least in part on an age of a player of the game session of the game program.

12. The method of claim 11 further comprising:
providing a menu of narration styles;
receiving an input selecting a narration style from the menu; and
providing the selected narration style with the video segment to the server.

13. The method of claim 11 wherein narration style is selected by the gaming console and provided to the server with the video segment.

14. The method of claim 13 wherein the narration is generated by the server using a machine learning model that has been trained to generate narrations of video segments of game sessions of the game program based at least in part on narration styles.

15. The method of claim 11 wherein the narration style is selected by the server.

16. A method of operating a gaming server, the method comprising:
receiving a video segment of a game session of a game program from a gaming console, the video segment including an event;
determining a rarity of the event;
generating a narration of the video segment, wherein the narration is based at least in part on the rarity of the event; and
providing the narration to the gaming console.

17. The method of claim 16 further comprising:
determining the presence of an event in the video segment using a machine learning model that has been trained to identify the presence of events in video segments of game sessions of the game program.

18. The method of claim 16 wherein determining a rarity of the event comprises:
using a first machine learning model that has been trained to identify the rarity of events in video segments of game sessions of the game program.

19. The method of claim 18 wherein generating the narration based at least in part on the rarity of the event comprises:
using a second machine learning model that has been trained to generate narrations of video segments based at least in part on the rarity of an event.

20. The method of claim 16 further comprising:
receiving a selection of a narration style, and generating the narration further based at least in part on the selected narration style.
